(19) United States
(12) Patent Application Publication
(10) Pub. No.: US 2023/0104195 A1
(43) Pub. Date: Apr. 6, 2023

(54) METHOD FOR PRODUCING PARTICLES AND APPARATUS FOR PRODUCING PARTICLES

(71) Applicant: ASAHI KASEI KABUSHIKI KAISHA, Tokyo (JP)

(72) Inventors: Keita YOSHITAKE, Tokyo (JP); Masahiko SUGIMOTO, Tokyo (JP); Akihide IIDA, Tokyo (JP)

(73) Assignee: ASAHI KASEI KABUSHIKI KAISHA, Tokyo (JP)

(21) Appl. No.: 17/909,906

(22) PCT Filed: Mar. 26, 2021
(86) PCT No.: PCT/JP2021/013120

§ 371 Date: Sep. 7, 2022

(30) Foreign Application Priority Data
Mar. 27, 2020 (JP) 2020-058985

(51) Int. Cl. B02C 19/18; C01G 23/00

(52) U.S. Cl. CPC B02C 19/18; C01G 23/006; C01P 2004/03; C01P 2004/04

(57) ABSTRACT

The purpose of the present invention is to provide a method for producing particles and an apparatus for producing particles, wherein fine particles can be more conveniently obtained compared to conventional top-down methods for generating fine particles, and spherical fine particles can be obtained like bottom-up methods for generating fine particles. An aspect of the present invention pertains to a method for producing particles, the method comprising: a step for mixing a substance containing a metal and/or a semi-metal with an explosive; a step for burning the explosive to cause a combustion reaction of the substance; and a step for capturing particles in a combustion gas obtained in the combustion reaction step.

### FIELD

The present invention relates to a method for producing particles and a particle production apparatus.

### BACKGROUND

Conventional fine particle generation methods are separated into bottom-up methods, wherein crystal nuclei are generated from colloidal-level dispersions dispersed in a liquid and grown to produce particles of a desired size, and top-down methods, wherein particles having a large particle size are pulverized to produce particles of a desired size. Since particles are produced in a pulverizing step in a top-down method, obtaining spherical particles is not possible (NPL 1). On the other hand, since particles are produced by growing crystal nuclei in a bottom-up method, although spherical particles can be obtained, the process of growing crystal nuclei takes time, and thus production efficiency is poor.

### CITATION LIST

### Patent Literature

[NPL 1] Konami Moriyoshi, supervised by Matsumoto Kanji, “Process Design and Trouble Shooting in Powder & Nanoparticle Processing: from Basic Physical Properties to Process Design Practice and Troubleshooting”, Techno Systems, Inc., 2014, November 13, pp. 155-159.

### SUMMARY

### Technical Problem

An object of the present invention is to provide a method for producing particles and a particle production apparatus, wherein fine particles can be more conveniently obtained compared to a conventional top-down method for fine particle generation and spherical fine particles can be obtained as in a bottom-up method for fine particle generation.

### Solution to Problem

The present inventors have discovered that the above object can be achieved by using the combustion of an explosive to cause a combustion reaction of a substance comprising a metal and/or a metalloid to generate particles and capturing the particles, and completed the present invention. Examples of the embodiment of the present invention are described in the following [1] to [18].

[1] A method for producing particles, comprising the steps of:

mixing a substance comprising a metal and/or a metalloid with an explosive;

causing a combustion reaction of the substance by combusting the explosive; and

capturing particles in a combustion gas obtained in the step of causing a combustion reaction.

[2] The method for producing particles according to item 1, wherein a particle size of the particles obtained in the capturing step is less than or equal to a particle size of the substance comprising a metal and/or a metalloid.

[3] The method for producing particles according to item 1 or 2, further comprising cooling particles in a combustion gas obtained in the step of causing a combustion reaction.

[4] The method for producing particles according to any one of items 1 to 3, wherein a particle size of the particles obtained in the cooling step is less than or equal to a particle size of the substance comprising a metal and/or a metalloid.

[5] The method for producing particles according to any one of items 1 to 4, wherein the explosive is a mixture comprising at least one selected from the group consisting of perchlorates, nitrates, nitro compounds, and nitric acid ester compounds.

[6] The method for producing particles according to any one of items 1 to 5, wherein the substance is a single metal or metalloid element or an alloy of two or more metal or metalloid elements.

[7] The method for producing particles according to any one of items 1 to 6, wherein the substance is a compound comprising a metal or metalloid element.

[8] The method for producing particles according to any one of items 1 to 7, wherein a temperature of the combustion reaction is 1000 K (726.85° C.) or higher.

[9] The method for producing particles according to any one of items 1 to 8, wherein a combustion pressure at the time of the combustion reaction is 0.1 MPa to 1000 MPa.

[10] The method for producing particles according to any one of items 1 to 9, wherein a coolant in the cooling step is a gas, a liquid, or a combination of two or more thereof.

[11] The method for producing particles according to item 10, wherein a temperature of the coolant is 77 K to 473 K (−196.15° C. to 199.85° C.).

[12] The method for producing particles according to item 10 or 11, wherein the coolant is a liquid.

[13] The method for producing particles according to any one of items 10 to 12, wherein the coolant is water.

[14] The method for producing particles according to any one of items 1 to 13, wherein the particles are brought into contact with a solid, a liquid, or a combination of two or more thereof and thereby captured in the capturing step.

[15] The method for producing particles according to item 14, wherein the particles are brought into contact with a liquid and thereby captured in the capturing step.

[16] The method for producing particles according to item 15, wherein the particles are brought into contact with water and thereby captured in the capturing step.

[17] The method for producing particles according to any one of items 1 to 16, wherein the particles obtained in the capturing step are solid-core particles.

[18] A particle production apparatus, comprising an explosive filling portion, an ignition portion, a guide portion, and a capturing portion, wherein

the explosive filling portion is configured to be Tillable with a mixture comprising a substance comprising a metal and/or a metalloid and an explosive;

the ignition portion is configured to ignite the mixture to initiate a combustion reaction;

the guide portion is configured to guide a product of the combustion reaction from the explosive filling portion to the capturing portion; and

the capturing portion is configured to be capable of storing a product of the combustion reaction.

### Advantageous Effects of Invention

According to the present invention, a method for producing particles and a particle production apparatus, wherein fine particles can be more conveniently obtained compared to a top-down method for fine particle generation and spherical fine particles can be obtained as in a bottom-up method for fine particle generation, can be provided.

### BRIEF DESCRIPTION OF DRAWINGS

FIG. 1 is a scanning electron microscope (SEM) image of an aluminum powder (particle size average of 27 μm) manufactured by Toyo Aluminum K.K.

FIG. 2 is a transmission electron microscope (TEM) image of particles obtained in Example 1 of the present invention.

FIG. 3 is a scanning electron microscope (SEM) image of a magnesium powder (particle size average of 500 μm) manufactured by Kanto Chemical Co., Inc.

FIG. 4 is a scanning electron microscope (SEM) image of a titanium powder (particle size average of 20 μm) manufactured by Wako Pure Chemical Industries, Ltd.

FIG. 5 is a transmission electron microscope (TEM) image of particles obtained in Example 2 of the present invention.

FIG. 6 is a schematic drawing which shows an embodiment of the particle production apparatus of the present disclosure.

### DESCRIPTION OF EMBODIMENTS

### <<Method for Producing Particles>>

The method for producing particles of the present disclosure comprises a mixing step of mixing a substance (also referred to herein as “raw material substance”) comprising a metal and/or a metalloid with an explosive, a combusting step of combusting the explosive to cause a combustion reaction of the raw material substance, and a capturing step of capturing particles obtained in the combusting step. By having the above configuration, spherical fine particles, preferably nano-sized spherical particles, can be conveniently obtained in the method for producing particles.

### <Explosive>

As used herein, the term “explosive” means a substance that causes a rapid combustion reaction (explosive combustion) triggered by heat or impact. Generally, an explosive refers to both a composition comprising a metal powder and a composition not comprising a metal powder. However, an explosive is defined herein as a composition not including a “substance comprising a metal and/or a metalloid” for convenience. In the method for producing particles of the present disclosure, spherical fine particles can be instantaneously formed from the raw material substance by using the rapid combustion energy of such an explosive. From the viewpoint of fine particle formability, it is preferable that the explosive be a substance in which the combustion temperature reaches a temperature of preferably 1000 K (726.85° C.) or higher, more preferably 2000 K (1726.85° C.) or higher, and even more preferably 3000 K (2726.85° C.) or higher, according to the calculation results of NASA's chemical equilibrium calculation program (NASA-CEA). The composition of the explosive is not particularly limited, but is preferably a mixture comprising at least one selected from the group consisting of perchlorates, nitrates, nitro compounds, and nitric acid ester compounds. Of these, the explosive is more preferably a mixture comprising at least one selected from the group consisting of perchlorates, nitro compounds, and nitric acid ester compounds from the viewpoint of high combustion energy. Of these, the explosive is more preferably a mixture comprising ammonium perchlorate from the viewpoint of facilitating mixing with the raw material substance.

### <Raw Material Substance>

The substance (also referred to herein as “raw material substance”) comprising a metal and/or a metalloid for combustion is not particularly limited as long as product particles (residue) are generated by the combustion of the explosive. Examples of the substance comprising a metalloid include single metalloid elements, alloys and compounds thereof, and substances having metalloid properties, for example, carbon materials such as graphite. Of these, the raw material substance is preferably a single metal element, a single metalloid element, an alloy comprising two or more metal or metalloid elements, or a compound comprising a metal element or a metalloid element. Of these, the raw material substance is more preferably a single metal or metalloid element selected from the group consisting of magnesium, aluminum, titanium, iron, nickel, copper, gallium, yttrium, zirconium, niobium, molybdenum, technetium, ruthenium, rhodium, palladium, cadmium, indium, tin, tungsten, rhenium, osmium, iridium, platinum, gold, silver, thallium, lead, bismuth, lanthanum, cerium, praseodymium, neodymium, promethium, samarium, europium, astatine, boron, silicon, germanium, arsenic, antimony, and tellurium; an alloy of two or more of these elements; or a compound comprising one or more of these elements, from the viewpoint of producibility of the product particles. Of these, the raw material substance is even more preferably a single metal selected from the group consisting of magnesium, aluminum, and titanium from the viewpoint of combustion energy.

The state of the raw material substance for combustion is not particularly limited, but is more preferably a liquid or a solid in facilitating a combustion reaction. Of these, a solid is most preferable from the viewpoint of density. When the raw material substance is a solid, the shape thereof is preferably a particle in facilitating a combustion reaction. The particle size of the raw material substance is preferably 1 μm to 3,000 μm, more preferably 5 μm to 1,000 μm, even more preferably 10 μm to 700 μm, and still more preferably 20 μm to 500 μm, from the viewpoint of facilitating a combustion reaction and controlling the particle size of the obtained product particles.

The raw material substance for combustion reaction is preferably mixed in a combustion reaction field of the explosive. A mixture (also referred to herein as “explosive composition”) of the explosive and the raw material substance is preferable in facilitating a combustion reaction. The composition of the explosive composition is not particularly limited as long as the explosive and the raw material substance undergo a combustion reaction. The lower limit of the amount of explosive may be, for example, 40 wt % or more, 50 wt % or more, 60 wt % or more, 70 wt % or more, 80 wt % or more, or 90 wt % or more, and the upper limit may be, for example, 98 wt % or less, 90 wt % or less, 80 wt % or less, 70 wt % or less, or 60 wt % or less, based on the total mass of the explosive composition. The lower limit of the amount of raw material substance may be, for example, 1 wt % or more, 5 wt % or more, or 10 wt % or more, and the upper limit may be, for example, 30 wt % or less, 25 wt % or less, or 20 wt % or less, based on the total weight of the explosive composition.

The explosive composition may further comprise a polymer binder. When the explosive composition comprises a polymer binder, the lower limit of the amount of the polymer binder may be, for example, 1 wt % or more, 5 wt % or more, or 10 wt % or more, and the upper limit thereof may be, for example, 30 wt % or less, 25 wt % or less, or 20 wt % or less, based on the total weight of the explosive composition. The explosive composition may comprise preferably 50 wt % or more and 90 wt % or less, and more preferably 60 wt % or more and 80 wt % or less of the explosive; preferably 5 wt % or more and 25 wt % or less, and more preferably 10 wt % or more and 20 wt % or less of the raw material substance; and preferably 5 wt % or more and 25 wt % or less, and more preferably 10 wt % or more and 20 wt % or less of the polymer binder, based on the total weight of the explosive composition. The amount of each component is selected so that the total amount is 100 wt %.

### <Combusting Step>

In the combusting step, the explosive undergoes combustion to cause a combustion reaction of the raw material substance to generate product particles. The combustion temperature of the explosive is not particularly limited, but is preferably 1000 K (726.85° C.) or higher according to the calculation results of NASA-CEA. Within this range, the combustion temperature of the explosive is more preferably 2000 K (1726.85° C.) or higher and even more preferably 3000 K (2726.85° C.) or higher from the viewpoint of energy.

The combustion pressure in the combusting step is not particularly limited as long as the explosive undergoes combustion. From the viewpoint of facilitating the combustion of the explosive, 0.1 MPa to 1000 MPa is preferable. Within this range, 0.1 MPa to 500 MPa, which is the range of combustion pressure of a general explosive, is more preferable. Within this range, 0.1 MPa to 30 MPa is most preferable from the viewpoint of facilitating capturing.

### <Capturing Step and Cooling Step>

The product particles generated in the combusting step are typically contained in a combustion gas released by the combustion of the explosive. The method for producing particles of the present disclosure comprises a capturing step of capturing product particles obtained in the above combusting step. Preferably, the particle size of the particles obtained in the capturing step is less than or equal to the particle size of the substance comprising a metal and/or a metalloid. More preferably, the particles obtained in the capturing step are solid-core (not hollow) particles. The method of capturing is not particularly limited as long as product particles can be recovered. For example, product particles are brought in contact with a solid, a liquid, or a combination of two or more thereof and thereby captured. Specifically, the combustion gas containing the product particles may be brought into contact with a solid such as a wall, the ground, or an inner surface of a container and thereby retained; or brought into contact with a liquid and thereby retained, or a combination thereof may be used. From the viewpoint of capturing efficiency, it is preferable that the product particles be captured by bringing the product particles into contact with a liquid, and it is more preferable that, for example, the product particles be transferred to and retained in the liquid. Even more preferably, the product particles are brought into contact with water and thereby captured, from the viewpoint of facilitating purification after capturing.

The method for producing particles of the present disclosure may further comprise, after the combusting step, cooling the product particles obtained in the combusting step. Preferably, as used herein, where the particle size of the particles obtained in the cooling step is less than or equal to the particle size of the substance comprising a metal and/or a metalloid, “cooling” means lowering the temperature of the product particles at a rate faster than cooling in air by bringing the product particles into contact with a substance (coolant) having a temperature lower than or equal to the temperature of the product particles. Since the method for producing particles of the present disclosure can suppress the agglomeration of product particles by including a cooling step, nano-sized spherical particles can be more easily obtained. The coolant may be a solid, a liquid, a gas, or a combination thereof. The cooling step may be carried simultaneously with the capturing step of capturing the product particles or after the capturing step. When the cooling step is carried out simultaneously with the capturing step, for example, the combustion gas containing particles that have undergone a combustion reaction is brought in contact with and retained by a solid such as a wall, the ground, or a side surface of a container having a temperature lower than or equal to that of the particles; or is brought in contact with and retained by a liquid having a temperature lower than or equal to that of the particles. By using a combination thereof, the cooling and the capturing of the product particles can be carried out simultaneously.

The temperature of the coolant is not particularly limited as long as the temperature is lower than or equal to that of the product particles and the temperature of the particles can be lowered more quickly than by cooling in air. When the coolant is a liquid, the temperature can be set so that the coolant does not disappear completely due to evaporation, depending on the coolant used. To suppress the growth of particles, the temperature of the coolant is more preferably 77 K to 473 K (−196.15° C. to 199.85° C.), and even more preferably 77 K to 373 K (−196.15° C. to 99.85° C.).

The substance of the coolant is preferably a gas, a liquid, or a combination of two or more thereof from the viewpoint of facilitating capturing after a reaction. From the viewpoint of production efficiency, a substance that can also be used in the capturing step, for example, a liquid, is preferable. From the viewpoint of handleability, water is more preferable.

The captured product particles can be separated and recovered from the liquid used for the capturing, as needed. For example, the product particles can be recovered by filtering the liquid containing the captured product particles and cleaning and drying the product particles. Further, the liquid containing the captured product particles may be allowed to stand to separate into a suspended matter (supernatant) dispersed with relatively small particles and a precipitate containing relatively large particles, both of which are filtered, cleaned, and dried, whereby small particles and large particles are separated and recovered. For the cleaning method, for example, the captured product particles can be cleaned with a cleaning solution such as acetone, water, or hydrochloric acid after neutralization.

### <<Product Particles>>

By using the method for producing particles of the present disclosure, spherical particles having a particle size less than or equal to that of the substance comprising a metal and/or a metalloid can be obtained. The particle size of product particles is preferably, for example, 10 nm to 100 μm, 10 nm to 50 μm, 10 nm to 10 μm, 10 nm to 1 μm, 10 nm to 500 nm, or 10 nm to 300 nm. Generally, when attempting to produce fine particles having a small particle size, for example, nanoparticles, by a top-down method, nanoparticlization is difficult unless a special mill is used, the submicron level is generally the limit, and the obtained particles are not spherical (NPL 1). In a bottom-up method, since particles are produced by growing crystal nuclei, nano-sized spherical particles can be obtained. However, since the process of growing crystal nuclei takes time, production efficiency is poor. The method for producing particles is a more convenient method compared to conventional top-down methods, and nano-sized spherical particles like those of bottom-up methods can be obtained.

As a method of controlling the particle size of the product particles to the above ranges, the particle size of the raw material substance is adjusted to preferably 100 nm to 3,000 μm, more preferably 100 nm to 1,000 μm, even more preferably 500 nm to 500 μm, and still more preferably 1 μm to 100 μm. In addition, the particle size of the product particles can be selectively controlled by the composition of the explosive, the ratio of the explosive and the raw material substance in the explosive composition, the temperature and the combustion pressure of the combustion reaction, the duration before cooling, and the temperature of the coolant.

The obtained particles can be, for example, at least one selected from the group consisting of oxides, nitrides, carbides, and an unreacted portion of a substance comprising a metal and/or a metalloid. When two or more substances comprising a metal and/or a metalloid are mixed and subjected to a combustion reaction, alloys of metal and/or metalloid elements contained in each substance or compounds (composites) thereof are obtained, in addition to oxides, nitrides, carbides, and an unreacted portion of each substance. The composite can be at least one selected from the group consisting of composite metal oxides, composite metal nitrides, and composite metal carbides.

For example, when aluminum is used as the raw material substance, aluminum oxide, aluminum nitride, aluminum carbide, or unreacted aluminum, etc., can be obtained. When titanium is used as the raw material substance, titanium oxide, titanium nitride, titanium carbide, or unreacted titanium can be obtained. When a mixture of titanium and magnesium is used as the raw material substance, a composite metal oxide, a composite metal nitride, or a composite metal carbide of titanium and magnesium can be obtained. When a mixture of aluminum and magnesium is used as the raw material substance, a composite metal oxide, a composite metal nitride, or a composite metal carbide of aluminum and magnesium can be obtained.

For the obtained particles, the product particles can be selectively controlled by the composition of the explosive, the reaction rate and the heat of formation of the substance comprising a metal and/or a metalloid, and the temperature of the coolant. For example, regarding the composition of the explosive, if the substance comprising a metal and/or a metalloid is subjected to a combustion reaction using an explosive having a low oxygen balance, an unreacted substance can be obtained while a downsizing effect and spherical characteristics are obtained.

### <<Particle Production Apparatus>>

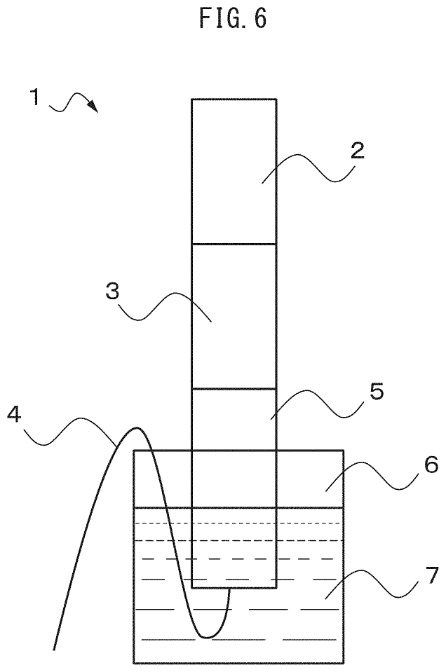

Hereinafter, the particle production apparatus 1 of the present disclosure will be described with reference to FIG. 6. The particle production apparatus 1 comprises a retention portion 2, an explosive filling portion 3, an ignition portion 4, a guide portion 5, and a capturing portion 6. Note that, the retention portion 2 can be omitted. The components described above may be disassembled as individual components, integrated as one from a plurality of components, or a combination thereof. Each component will be described below.

The explosive filling portion 3 is configured to be fillable with an explosive composition, which is a mixture comprising a substance (raw material substance) comprising a metal and/or a metalloid and an explosive. The explosive filling portion 3 is coupled to the guide portion 5 and configured for communication with each other. Examples of a “coupled” state include welding, bonding, and connecting by a fixture, and the same applies hereinafter. The explosive filling portion 3 is not particularly limited as long as the portion has a shape that enables filling of the explosive composition, but at least a portion of the explosive filling portion is open so that the combustion product of the explosive composition can be moved to the capturing portion 6 through the guide portion 5. In one embodiment of the present disclosure, the explosive filling portion 3 has a hollow shape with an opening, and the opening communicates with the guide portion 5 having a hollow, tubular shape.

The guide portion 5 is configured to guide the product of the combustion reaction from the explosive filling portion 3 to the capturing portion 6. Specifically, the guide portion 5 has a tubular shape, which has one end coupled to the explosive filling portion 3 and the other end positioned inside the capturing portion 6. The shape of the guide portion 5 is not limited, but is preferably a straight, tubular shape from the viewpoint of preventing adhesion of the combustion product of the explosive composition on the inner wall of the guide portion 5. The cross section of the tube may be, for example, a circle, an ellipse, a polygon with 3 to 100 vertices, or any of other shapes similar thereto.

The ignition portion 4 is configured to ignite the above mixture, i.e., the explosive composition, and initiate a combustion reaction. Specifically, the ignition portion 4 is a nichrome wire attached to a tip of a string-like conducting wire and is configured such that one end to which the nichrome wire is attached is connected to the explosive composition and the other end is positioned outside the particle production apparatus 1. By energizing the one end of the ignition portion 4 positioned outside the particle production apparatus 1, a combustion reaction of the explosive composition inside the explosive filling portion 3 is initiated by joule heating of the nichrome wire. The combustion reaction of the explosive composition proceeds in a combustion reaction portion (not shown), which is a portion inside the explosive filling portion 3 and the guide portion 5. In FIG. 6 as an embodiment of the present disclosure, the ignition portion 4 passes through the interior of the explosive filling portion 3, the guide portion 5, and the capturing portion 6 and exits to the outside of the particle production apparatus 1.

The capturing portion 6 is configured to be capable of storing a product of the combustion reaction. Specifically, the capturing portion 6 is a container for recovering a product of the combustion reaction. The product of the combustion reaction may be brought into contact with a solid such as the inner surface of the capturing portion 6 and thereby captured or may be brought into contact with a liquid in the capturing portion 6 and thereby retained, or a combination thereof may be used. From the viewpoint of capturing efficiency, it is preferable that the product of the combustion reaction be captured by bringing the product into contact with a liquid in the capturing portion 6, and more preferable that the product be transferred to and retained in the liquid. It is even more preferable that the liquid be water, from the viewpoint of facilitating purification after capturing. In FIG. 6 as an embodiment of the present disclosure, the capturing portion 6 is filled with water as the capturing liquid. In addition, the guide portion 5 is inserted into the inner surface of the capturing portion 6, and one end of the guide portion 5 is positioned in the capturing liquid 7. Although not illustrated in FIG. 6, it is preferable that the capturing portion 6 be fixed with, for example, a clamp so as not to move due to impact from the combustion of the explosive composition.

The particle production apparatus 1 may further comprise a retention portion (not illustrated). The retention portion is coupled to, for example, the explosive filling portion 3 and is retained by, for example, a clamp so that the particle production apparatus does not move due to impact from the combustion of the explosive composition. The shape of the retention portion is not limited, but is preferably rod-shaped from the viewpoint of facilitating retention.

### EXAMPLES

Hereinafter, the present invention will be further described using the Examples. However, the present invention is not limited to the following Examples.

### <<Measurement and Analysis Methods>>

### <Particle Size and Shape of Raw Material Substance>

The particle size of the substance comprising a metal and/or a metalloid, or the raw material substance, was measured as follows, using a laser diffraction particle size analyzer (LA-950, manufactured by HORIBA, Ltd.).

1) A sample was prepared with water as a dispersion medium.
2) A pretreatment with an ultrasonic machine built into the measuring instrument was carried out for 10 min.
3) The particle size distribution was measured, and the particle size was evaluated by the median diameter (d50) determined from the distribution curve.

The shape of the substance comprising a metal and/or a metalloid, or the raw material substance, was observed using a scanning electron microscope (SEM) (JSM-7400F, manufactured by JEOL Ltd.).

### <Composition and Crystal Structure of Product Particles>

The composition and the crystal structure of the product particles were measured as follows, using an X-ray diffractometer (XRD) (“Smart Lab”, manufactured by Rigaku Corporation).

1) A sample was set in a sample measurement holder.
2) The sample was measured and evaluated under the conditions of 40 kv/30 mA, Cu/Kβ line, a scan speed of 10 deg/min, and a scan range of 15 to 90.

### <Particle Size and Shape of Product Particles>

The particle size and the shape of the product particles were measured as follows, using a transmission electron microscope (TEM) (JEM-2011, manufactured by JEOL Ltd.).

1) Any plurality of particles (100 or more) were directly observed, diameters of the particles were each calculated from aspect ratios of projected two-dimensional images, and an average particle size thereof was calculated.

### Example 1

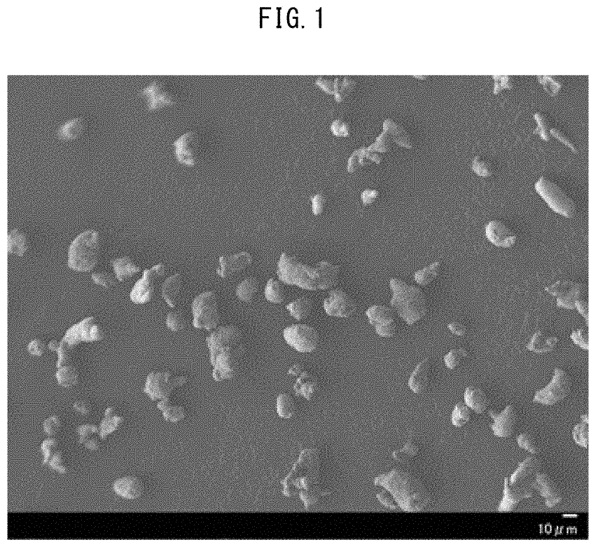

An aluminum powder as a raw material substance was mixed into an explosive to obtain an explosive composition. The composition of the explosive composition was a mixture of 15 wt % (FIG. 1, particle size average of 27 μm) of an aluminum powder from Toyo Aluminum K.K., 70 wt % of ammonium perchlorate from Japan Carlit Co., Ltd., and 15 wt % of a polymer binder. The explosive underwent combustion, and particles generated by the combustion reaction were captured. For the capturing of product particles, water was used as a coolant and a capturing liquid, and the combustion gas was bubbled into the water to collect the product particles in the water.

More specifically, the particle generating apparatus described above was used in the above combustion, cooling, and capturing. The explosive filling portion was filled with a raw material substance and an explosive that were mixed into an explosive composition. The explosive was ignited from the tip of the explosive filling portion, and a combustion gas containing particles generated from a combustion reaction in the combustion reaction portion were bubbled into water used as a coolant and a capturing liquid, whereby product particles were cooled and captured. The combustion temperature from NASA-CEA of the explosive used for the combustion reaction was 2650° C. The combustion pressure at the time of combustion can be set by adjusting an outlet diameter of the combustion reaction portion during transfer from the combustion reaction portion to the coolant. In the present example, the combustion pressure at the time of combustion was 0.1 MPa to 0.2 MPa without adjusting the outlet diameter. The temperature of the water used as the coolant and the capturing liquid was 20° C. The captured product particles were cleaned with water and acetone and dried at 100° C. at 12 h.

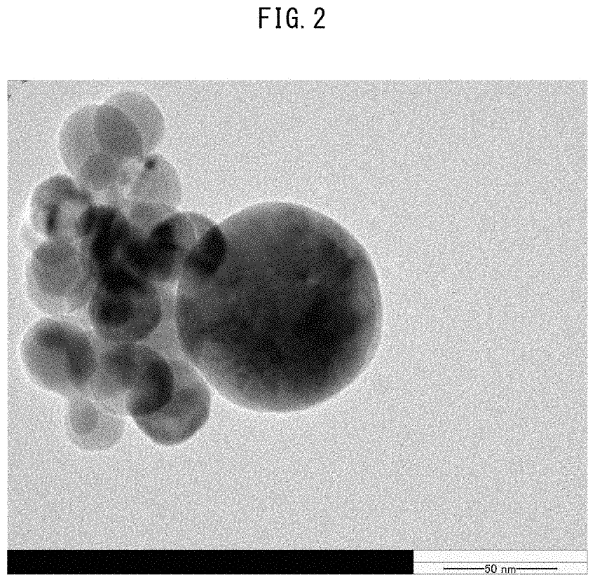

To verify the crystal structure, shape, and particle size of the product particles, the product particles were analyzed using an X-ray diffractometer (XRD) (Smart Lab, manufactured by Rigaku Corporation) and a transmission electron microscope (TEM) (JEM-2011, manufactured by JEOL Ltd.). The XRD analysis results are shown in Table 1, and the TEM analysis results are shown in FIG. 2. In addition, the XRD analysis results were matched with card number 01-079-1558 of the ICDD-PDF2 database, and crystals of γ-alumina were identified.

TABLE 1

| | Intensity |
|---|---|
| 2θ (deg) | (cps) |
| 19.38 | 2700 |
| 31.965 | 6035 |
| 37.554 | 13880 |
| 39.404 | 12167 |
| 45.795 | 65889 |
| 56.882 | 1924 |
| 60.824 | 4903 |
| 66.8603 | 77363 |
| 76.67 | 710 |
| 79.24 | 789 |
| 84.883 | 5531 |
| 88.38 | 229 |

It was verified that from the combustion of the explosive, solid-core nanoparticles (particle size: 70 nm) of γ-alumina were generated from μm-size aluminum.

### Example 2

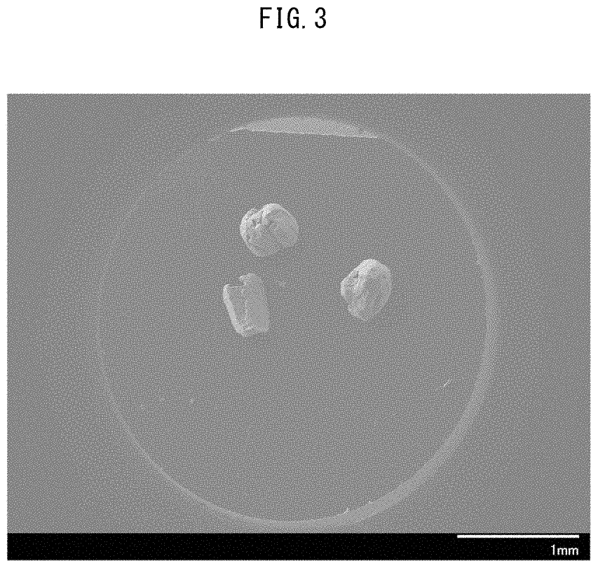

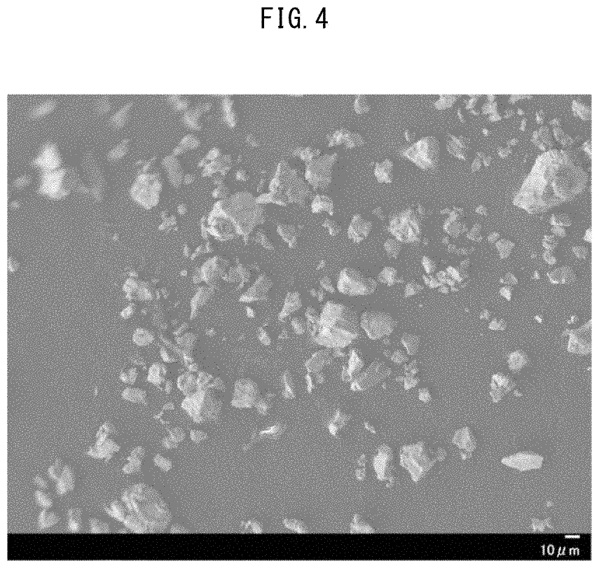

Titanium and magnesium as substances comprising a metal and/or a metalloid were contained in an explosive, and particles generated by a combustion reaction were captured. The composition of the explosive was a mixture of 7.5 wt % (FIG. 3, particle size average of 500 μm) of a magnesium powder from Kanto Chemical Co., Inc., 7.5 wt % (FIG. 4, particle size average of 20 μm) of a titanium powder from Wako Pure Chemical Industries, Ltd., and 70 wt % of ammonium perchlorate from Japan Carlit Co., Ltd., and 15 wt % of a polymer binder. The capturing and analysis methods of the product particles were the same as those in Example 1.

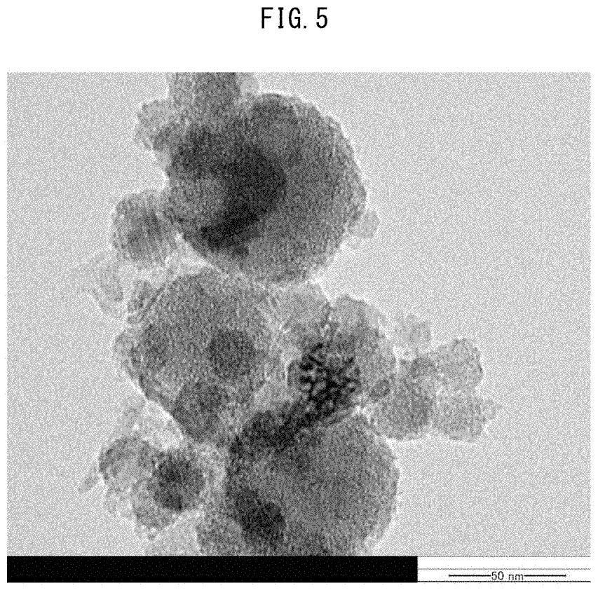

The combustion temperature from NASA-CEA of the explosive used for the combustion reaction was 2500° C. In the present example, the combustion pressure at the time of combustion was 0.1 MPa to 0.2 MPa without adjusting the outlet diameter of the combustion reaction portion. The temperature of the water used as the coolant and the capturing liquid was 20° C. The captured product particles were cleaned with water and acetone and dried at 100° C. for 12 h. To verify the shape and the particle size of the product and the fine particles thereof, the product particles were analyzed using an X-ray diffractometer (XRD) (Smart Lab, manufactured by Rigaku Corporation) and a transmission electron microscope (TEM) (JEM-2011, manufactured by JEOL Ltd.). The XRD analysis results are shown in Table 3, and the TEM analysis results are shown in FIG. 5. The XRD analysis results were matched with card number 01-080-2548 of the ICDD-PDF2 database, and crystals of TiMgO₃ were identified.

TABLE 2

| | Intensity |
|---|---|
| 2θ (deg) | (cps) |
| 19.026 | 1476 |
| 21.141 | 1395 |
| 32.813 | 13743 |
| 35.414 | 6669 |
| 56.966 | 827 |
| 66.93 | 1094 |
| 68.87 | 367 |

It was verified that from the combustion of the explosive, solid-core nanoparticles (particle size: 60 nm) of the composite metal oxide (compound) TiMgO₃ were generated from μm-size titanium and magnesium.

### REFERENCE SIGNS LIST

1 particle production apparatus
2 retention portion
3 explosive filling portion
4 ignition portion
5 guide portion
6 capturing portion
7 capturing liquid

1. A method for producing particles, comprising:
mixing a substance comprising a metal and/or a metalloid with an explosive;
causing a combustion reaction of the substance by combusting the explosive; and
capturing particles in a combustion gas obtained in the causing a combustion reaction.

2. The method for producing particles according to claim 1, wherein a particle size of the particles obtained in the capturing is less than or equal to a particle size of the substance comprising a metal and/or a metalloid.

3. The method for producing particles according to claim 1, further comprising cooling particles in a combustion gas obtained in the causing a combustion reaction.

4. The method for producing particles according to claim 3, wherein a particle size of the particles obtained in the cooling is less than or equal to a particle size of the substance comprising a metal and/or a metalloid.

5. The method for producing particles according to claim 1, wherein the explosive is a mixture comprising at least one selected from the group consisting of perchlorates, nitrates, nitro compounds, and nitric acid ester compounds.

6. The method for producing particles according to claim 1, wherein the substance is a single metal or metalloid element or an alloy of two or more metal or metalloid elements.

7. The method for producing particles according to claim 1, wherein the substance is a compound comprising a metal element or a metalloid element.

8. The method for producing particles according to claim 1, wherein a temperature of the combustion reaction is 1000 K (726.85° C.) or higher.

9. The method for producing particles according to claim 1, wherein a combustion pressure at the time of the combustion reaction is 0.1 MPa to 1000 MPa.

10. The method for producing particles according to claim 3, wherein a coolant in the cooling is a gas, a liquid, or a combination of two or more thereof.

11. The method for producing particles according to claim 10, wherein a temperature of the coolant is 77 K to 473 K (−196.15° C. to 199.85° C.).

12. The method for producing particles according to claim 10, wherein the coolant is a liquid.

13. The method for producing particles according to claim 10, wherein the coolant is water.

14. The method for producing particles according to claim 1, wherein the particles are brought into contact with a solid, a liquid, or a combination of two or more thereof and thereby captured in the capturing.

15. The method for producing particles according to claim 14, wherein the particles are brought into contact with a liquid and thereby captured in the capturing.

16. The method for producing particles according to claim 15, wherein the particles are brought into contact with water and thereby captured in the capturing.

17. The method for producing particles according to claim 1, wherein the particles obtained in the capturing are solid-core particles.

18. A particle production apparatus, comprising an explosive filling portion, an ignition portion, a guide portion, and a capturing portion, wherein
the explosive filling portion is configured to be fillable with a mixture comprising a substance comprising a metal and/or a metalloid and an explosive;
the ignition portion is configured to ignite the mixture to initiate a combustion reaction;
the guide portion is configured to guide a product of the combustion reaction from the explosive filling portion to the capturing portion; and
the capturing portion is configured to be capable of storing a product of the combustion reaction.
